(19) United States
(12) Patent Application Publication
(10) Pub. No.: US 2008/0073291 A1
(43) Pub. Date: Mar. 27, 2008

(54) AGENTS AND METHODS FOR REMOVING CHLORAMINE, CHLORINE, AND OTHER ACTIVE CHLORINE COMPOUNDS FROM WATER USED FOR KEEPING WATER ORGANISMS

(75) Inventor: Gunter RITTER, Bunde (DE)

Correspondence Address: MERCHANT & GOULD PC, P.O. BOX 2903, MINNEAPOLIS, MN, 55402-0903, US

(73) Assignee: Tetra GmbH, Melle (DE)

(21) Appl. No.: 11/857,638

(22) Filed: Sep. 19, 2007

(30) Foreign Application Priority Data
Sep. 22, 2006 (DE) 102006045332.8

(51) Int. Cl. C02F 1/70

(52) U.S. Cl. 210/757

(57) ABSTRACT

The invention describes novel agents und methods thereof for removing chloramine, chlorine, and other active chlorine compounds from water used for keeping organisms living in aquariums, garden ponds, or other aquaculture systems. The agents consist of sodium hydrogen sulfite, salts and organic derivatives thereof, or adducts of sodium hydrogen sulfite, preferably an adduct of aliphatic aldehydes of the general formula

X—(CH₂)ₙ—CO—H,
wherein
n means the numbers 0 to 3 and
X means a —OH, —COOH or —CO—H group,
   wherein X may not be —OH if n=0.

### BACKGROUND OF THE INVENTION

The invention describes novel agents and methods for removing chloramine, chlorine, and other active chlorine compounds from water and domestic water (e.g. water for watering plants) intended as water for keeping water organisms in aquariums, garden ponds, or aquaculture systems.

Chloramine, chlorine, and other active chlorine compounds in water used for keeping aquatic organisms and domestic water originate for the most part from additives to disinfectingly treat biologically contaminated water (from groundwater, lakes, rivers, etc.) to make tap water.

### SUMMARY OF THE INVENTION

The agents described according to the invention have not been used for the purpose that is described in more detail in the following and have considerable advantages compared to agents and methods of the prior art.

Up to now, for removing chloramine, chlorine, and other active chlorine compounds from fresh tap water, water used for keeping aquatic organisms, and domestic water, to which fresh tap water has been added, a series of reducing agents was and is being used, which have deficiencies and disadvantages compared to the agents described in this invention.

In the following consideration, special emphasis is placed on the chemical behavior with regard to chloramine since its use for disinfecting tap water is known worldwide and is still gaining in importance.

For safety reasons, the reducing agent is, for the most part, used in stoichiometrical excess, especially since the exact content of chloramine already present in the drinking water is not known.

The reducing agent thiosulfate which has been used to remove chlorine for decades reacts with chloramine in a molar ratio of 2:1, a tetrathionate, S₄O₆²⁻, being formed. Here, the use of a high molar amount of chloramine is required. The tetrathionate formed is microbiologically oxidized to sulfate with relatively high consumption of oxygen. In the process, 4 mole of sulfate are formed per mole of S₄O₆²⁻.

The use of sodium hydroxymethane sulfonate is described in EP-A 0 203 741. Na(HO—CH₂—SO₃⁻) is well suited for the reduction of chloramine, however, it has the serious disadvantage that during the reduction with H₂NCl, formaldehyde is released that today is considered obsolete in biological systems.

The use of sodium hydroxymethane sulfinate is described in EP-B 0 278 515. Besides a number of advantages compared to sodium hydroxymethane sulfonate, namely the higher reactivity and more economical substance use, here the following disadvantages exist: sodium hydroxymethane sulfinate is very unstable in solution if it is not stabilized by suitable additives. As described for the sulfonate, the formation of formaldehyde in the reaction with chloramine is undesirable here as well.

Currently, other reducing agents are not usually employed in the technology of water treatment in biological systems.

It has now been found, that, surprisingly, chemical compounds are particularly easily accessible that may surprisingly effectively be used for reducing chloramine, chlorine, and other active chlorine compounds and have important advantages compared to agents of the prior art.

Despite of their partly simple composition und the fact that they already have found broad use in other areas of chemical technology for a long time, they have not been used in water used for keeping aquatic organisms and domestic water for the purpose according to the invention.

The reducing agents according to the invention are derived from sulfurous acid, H₂SO₃, salts thereof, and organic derivatives of hydrogen sulfite, HSO₃⁻, in particular the following salts and adducts:
salts having the hydrogen sulfite anion, HSO₃⁻, mainly NaHSO₃
salts having the sulfite anion, SO₃²⁻, mainly Na₂SO₃
salts having the meta-bi-sulfite anion, S₂O₅²⁻, mainly Na₂S₂O₅
adducts of (sodium) hydrogen sulfite, (NaHSO₃), HSO₃⁻ with aliphatic mono- and dialdehydes of the general formula

X—(CH₂)ₙ—CO—H,
wherein
n means the numbers 0 to 3 and
X means a —OH, —COOH or —CO—H group,
wherein X may not be —OH if n=0.

The reducing agents according to the invention are formed according to the following chemical equations:

R₁—CHO+HSO₃⁻→R₁—CH(OH)SO₃⁻ Chemical Equation I

and

OHC—R₂—CHO+2 HSO₃⁻→⁻O₃S(OH)CH—R₂—CH(OH)SO₃⁻ Chemical Equation II

The moieties R₁ and R₂ correspond to the respective organic moieties of the aldehydes used of the general formula above.

For example, the following aldehydes and homologues thereof may be used:

### Aliphatic Monoaldehydes

Acetaldehyde
Propionaldehyde
(Formaldehyde is not used for the reasons given above)

### Aliphatic Hydroxyaldehydes

Glycolaldehyde
Glyceric aldehyde

### Aliphatic Aldehydo-Carboxylic Acids

Glyoxylic acid

### Aliphatic Dialdehydes

Glyoxal
Malondialdehyde
Succindialdehyde
Glutardialdehyde

In all examples mentioned, the part that is reactive toward chloramine is hydrogen sulfite, sulfite, or the sulfonate group in the adducts with aliphatic aldehydes that is present in small amounts as hydrogen sulfite in a dissociation or adduct forming equilibrium or is supplied with progression of the reaction in accordance with the mass action equation.

The agents according to the invention have in particular the following advantages:
A very fast, defined reaction of HSO₃⁻ or SO₃²⁻ with chloramine according to:

HSO₃⁻+H₂NCl+H₂O→SO₄²⁻+Cl⁻+NH₄₊+H⁺

or

SO₃²⁻+H₂NCl+H₂O→SO₄²⁻+Cl⁻+NH₄⁺
in equimolar stoichiometry
Exclusively sulfate is formed in a non-ambiguous reaction.
A subsequent, O₂-consuming microbiological oxidation reaction of sulfur-rich intermediates is dispensed with.
The agents exhibit a very good tolerance in fish and other water organisms and in liquid product preparations feature an unexpectedly high stability in a large pH range, for example from pH 3 to pH 9. In weakly acidic to neutral product preparations, NaHSO₃ and the NaHSO₃-adducts of aliphatic aldehydes may be advantageously used. In neutral to weakly basic product preparations, Na₂SO₃ and most NaHSO₃-adducts of aliphatic aldehydes may be advantageously used. When using NaHSO₃ in the weakly acidic range (pH 3-5), there is no loss of SO₂ in glass bottles. Losses may also be easily avoided if NaHSO₃-adducts with aliphatic aldehydes are used. The most important agents according to the invention, NaHSO₃, Na₂SO₃, the bis-NaHSO₃-adducts with glyoxal and glutardialdehyde, are extraordinarily inexpensive. Adducts of NaHSO₃ with uncommon aliphatic aldehydes that are not available on the market may be prepared from a NaHSO₃-solution and the respective aldehyde and separated from the reaction mixture in a simple fashion and in good yields since their solubility either in the product solution itself or especially in a 38-40% NaHSO₃-solution is very low.

The compounds mentioned may be used for the purpose according to the invention alone or in any combination.

Since all compounds mentioned react with H₂NCl speedily and completely in accordance with the reaction described for HSO₃⁻ and SO₃²⁻ even in high dilution, it is sufficient to add an equimolar amount adjusted to the chloramine concentration present (or, based on HSO₃⁻, SO₃²⁻ or the SO₃⁻ sulfonate group in the aldehyde adducts, in particular with a slight—for example 5-10 mol %—excess) to the water. Since as salts, the compounds have good water solubility, the desired amount of reducing agent may be added in dissolved or suspended form or as powder, pressed article, pellets, tablets, etc. The reduction of H₂NCl, chlorine, and other active chlorine compounds is completed within a few minutes.

The dosing of the reducing agents (based on the chemically redox-active HSO₃⁻, SO₃²⁻-anions or the sulfonate group in the aldehyde adducts) occurs equimolar (preferably with a slight excess of 5-10 mol %) to the concentration of chloramine (H₂NCl).

The addition of chloramine to drinking water is carried out to a different extent in different regions of the world:
USA: up to 5 mg/L of H₂NCl
Europe: up to 2-3 mg/L of H₂NCl (on average a maximum of 2.5 mg/L of H₂NCl)
5 mg/L of H₂NCl=97.1 μmol/L
2.5 mg/L of H₂NCl=48.6 μmol/L

For neutralization or complete reduction, in the USA −97.1 μmol/L of HSO₃⁻, R-SO₃⁻ is required, and in European states −48.6 μmol/L of HSO₃⁻, R-SO₃⁻ is required. For safety reasons, an excess of 5-10 mol % is provided since H₂NCl (and other active chlorine compounds) are highly toxic for fish and other water organisms. Depending upon the different formula weights of the agents according to the invention, correspondingly, different weight amounts have to be dosed.

In the following tables, the required weight amounts for equimolar amounts of the individual substances are summarized. A molar excess of 5-10 mol % was not allowed for in the tables.

NaHSO₃, Na₂SO₃, glyoxal-bis-NaHSO₃-adduct and glutardialdehyde-bis-NaHSO₃-adduct are the preferentially used compounds.

TABLE I

| | Formula | 2.5 mg/L of | 5.0 mg/L of |
|---|---|---|---|
| Compound | Weight | H₂NCl | H₂NCl |
| NaHSO₃ | 104.06 | 5.1 mg/L | 10.1 mg/L |
| NaHSO₃ | 126.04 | 6.1 mg/L | 12.2 mg/L |
| Glyoxal•2NaHSO₃ | 266.17 | 6.5 mg/L | 12.9 mg/L |
| Glutardialdehyde•2NaHSO₃ | 308.24 | 7.5 mg/L | 15.0 mg/L |

In the following table, the agents and the required dosages thereof that have a secondary role as chloramine reducing agents but are also used for this purpose are summarized.

TABLE II

| | Formula | 2.5 mg/L of | 5.0 mg/L of |
|---|---|---|---|
| Compound | Weight | H₂NCl | H₂NCl |
| Na₂S₂O₅ | 190.10 | 4.6 mg/L | 9.2 mg/L |
| Acetaldehyde•NaHSO₃ | 148.11 | 7.2 mg/L | 14.4 mg/L |
| Propionaldehyde•NaHSO₃ | 162.14 | 7.9 mg/L | 15.8 mg/L |
| Glycolaldehyde•NaHSO₃ | 164.11 | 8.0 mg/L | 16.0 mg/L |
| Glyceric aldehyde•NaHSO₃ | 194.14 | 9.4 mg/L | 18.9 mg/L |
| Glyoxylic acid•NaHSO₃ | 178.10 | 8.7 mg/L | 17.3 mg/L |
| Malondialdehyde•2NaHSO₃ | 280.18 | 6.8 mg/L | 13.6 mg/L |
| Succindialdehyde•2NaHSO₃ | 294.21 | 7.1 mg/L | 14.3 mg/L |

In the two tables I and II, the stoichiometric dosages for all described reducing agents for the complete reduction of a maximum of 2.5 mg/L of chloramine (EU) and a maximum of 5.0 mg/L of chloramine (USA) were listed.

If one also adds about 10% of safety additions, one comes up with safe required dosages that are based on the amount of added fresh, with chloramine loaded tap water of about 6-11 mg/L (for 2.5 mg/L of H₂NCl) and about 11-22 mg/L (for 5.0 mg/L of H₂NCl).

With the preferably used reducing agents NaHSO₃, Na₂SO₃, glyoxal•2NaHSO₃, and glutardialdehyde•2NaHSO₃ one needs application concentrations between 6-9 mg/L (2.5 mg/L of H₂NCl) and 12-18 mg/L (5.0 mg/L of H₂NCl). If one doses these amounts prior to or during a water change (with addition of fresh tap water) into the water used for keeping aquatic organisms or generally into the tap water prior to its use as domestic water, chloramine, chlorine, and other active chlorine compounds are safely, speedily, and completely reductively eliminated, so that the organisms, for example fish, that come into contact with the fresh tap water in aquariums and garden ponds are completely protected.

All mentioned reducing agents may be added
in dissolved form in a product solution,
in solid form as powder, tablet, pressed article, pellets
as suspension
   to the systems used for keeping aquatic organisms.

The following examples serve to illustrate the invention and do not limit it in any way.

### EXAMPLE 1

### Tap Water Treatment System for Aquariums

Dosage: 100 mL for 200 liter of water
Chloramine reduction capacity: 2.5 mg/L
   Metal complexing agent
   Hydrocolloids as mucous membrane protector
   B vitamins
   Dyes
   Reducing agents for removing 2.5 mg/L of chloramine
      NaHSO₃: 12 g/L
         or
      Na₂SO₃: 15 g/L
         or
      Glyoxal.2NaHSO₃: 15 g/L
         or
      Glutardialdehyde.2 NaHSO₃: 17 g/L

### Optionally, different reducing agents may also be combined, for example for the above recipe

NaHSO₃: 6.0 g/L
   plus
Glyoxal.2NaHSO₃: 7.5 g/L
   or
Na₂SO₃: 7.5 g/L
   plus
Glyoxal.2NaHSO₃: 7.5 g/L

### EXAMPLE 2

### Tap Water Treatment System for Aquariums

Dosage: 100 mL for 200 liter of water
Chloramine reduction capacity: 5.0 mg/L
   Recipe components as under Example 1
   Reducing agents for removing 5.0 mg/L of chloramine
      NaHSO₃: 24.0 g/L
         or
      Na₂SO₃: 30.0 g/L
         or
      Glyoxal.2NaHSO₃: 30.0 g/L
         or
      Glutardialdehyde.2 NaHSO₃: 34.0 g/L
         or the combinations
      NaHSO₃: 12.0 g/L
         plus
      Glyoxal.2NaHSO₃: 15.0 g/L
         or
      Na₂SO₃: 15.0 g/L
         plus
      Glyoxal.2NaHSO₃: 15.0 g/L

### EXAMPLE 3

### Tap Water Treatment System for Garden Ponds

Dosage: 500 mL for 10,000 liter of water
Chloramine reduction capacity: 2.5 mg/L
   Metal complexing agent
   Hydrocolloids as mucous membrane protector
   B vitamins
   Dyes
   Reducing agents for removing 2.5 mg/L of chloramine
      NaHSO₃: 120.0 g/L
         or
      Na₂SO₃: 150.0 g/L
         or
      Glyoxal.2NaHSO₃: 150.0 g/L

In Example 3, the required amount used of glyoxal.2NaHSO₃ per liter exceeds the solubility that is at about 50-60 g/L. Here, it is advantageous to add the remaining amount of glyoxal.2NaHSO₃ that exceeds the solubility as suspension, possibly stabilized by a suspension stabilizer.

### EXAMPLEs 4, 5, 6

A liquid, monofunctional product may also be prepared which contains as the sole component the chloramine reducing agent or mixtures of different chloramine reducing agents.

The product concentrations are identical with the specifications of examples 1-3.

### EXAMPLEs 7, 8, 9

Besides liquid preparations, the reducing agents that are available in crystalline or solid form may also be added in solid form to the systems used for keeping aquatic organisms.

Galenically possible are
Powder or powder mixtures (Example 7)
Pellets (Example 8)
Tablets (Example 9)

The dosages in the water used for keeping aquatic organisms are identical to the dosages that were described in Examples 1-3. The content of the reducing agents in the different preparations is defined by the range of the subunits, for example 1 tablet per 20 L of water or 1 measuring spoon of pellets or powder per 10 L of water. By means of the dosages given above (table values, plus 5-10%), the contents of the individual reducing agents or mixtures thereof in the solid preparations with defined chloramine reduction capacity per dosage unit may be calculated.

In addition, the solid preparations may also contain other functional components, for example
Complexing agents
Hydrocolloids
Vitamins
Galenic auxialliary agents
Dyes
Diluting/thinning agents

1. Methods and agents for water treatment by removing chloramine, chlorine, and other active chlorine compounds from water used for keeping water organisms using at least one reducing agent that is derived from sulfurous acid, salts, organic derivatives, and adducts thereof.

2. Methods and agents according to claim 1, wherein the organic derivatives and adducts consist of aldehydes of the general formula
X—(CH₂)ₙ—CO—H,
wherein
n means the numbers 0 to 3 and
X means a —OH, —COOH or —CO—H group,
wherein X may not be —OH if n=0.

3. Methods and agents according to claim 1, wherein aldehyde, at least one aliphatic mono- or dialdehyde from the group of acetaldehyde, propionaldehyde, glycolaldehyde, glyceric aldehyde, glyoxylic acid, glyoxal, malondialdehyde, succindialdehyde, or glutardialdehyde is used.

4. The method of claim 1, wherein aldehyde, malondialdehyde, succindialdehyde, glycolaldehyde, glyceric aldehyde, or glyoxylic acid are used.

5. The method of claim 1, wherein the adduct is used in a concentration of 40 to 100 μmol/L of HSO₃⁻ or R-SO₃⁻.

6. The method of claim 3, wherein a molar excess of 5-10 mol % is added.

7. The method of claim 5, wherein the adduct is used in water used for keeping aquatic organisms at a pH of 3 to 9.
